(19) United States
(12) Patent Application Publication
(10) Pub. No.: US 2019/0019163 A1
(43) Pub. Date: Jan. 17, 2019

(54) SMART MESSAGING IN MEDICAL PRACTICE COMMUNICATION

(71) Applicant: EasyMarkit Software Inc., Vancouver (CA)

(72) Inventors: Andrew Batey, Vancouver (CA); Anton Laptiev, Vancouver (CA)

(73) Assignee: EasyMarkit Software Inc., Vancouver (CA)

(21) Appl. No.: 15/650,573

(22) Filed: Jul. 14, 2017

(51) Int. Cl. G06Q 10/10; G06F 19/00

(52) U.S. Cl. CPC G06Q 10/1095; G06Q 10/10; G06F 19/322; G06F 19/323

(57) ABSTRACT

Described herein are techniques and mechanisms for facilitating communications with patients of a medical practice. Patients of a medical practice may be grouped into clusters based on similar characteristics as represented in data associated with those patients. For example, patients may be clustered based on demographic data, stated communications preference data, observational data about patient behavior, clinic data characterizing a medical practice visited by the patient, and/or other such information. A default communications pattern may be determined for each cluster. The default communications pattern may include information related to communications content, channel, ordering, frequency, timing, and/or other such information for communicating with patients in the cluster. Messages may then be scheduled with patients in a cluster in accordance with the default communications pattern.

### TECHNICAL FIELD

The present disclosure relates to the customization, scheduling, transmission, confirmation, and tracking of messages to patients of a medical practice.

### DESCRIPTION OF RELATED ART

Managing a modern medical practice requires overcoming significant challenges in the area of information technology. Patient data is increasingly stored and managed in digital rather than paper records. However, many jurisdictions substantially restrict the sharing and distribution of medical records in an effort to protect patient privacy. In addition, security concerns are paramount when dealing with patient medical record data, since a data breach could reveal sensitive information for thousands or millions of patients. Complicating matters further is the fact that investigating, implementing, and maintaining complex information technology is outside the area of expertise of most medical practitioners, assistants, and administrators.

One area of technology that presents particular information technology challenges to a modern medical practice is patient messaging. Medical practices typically contact patients to confirm appointments since missed appointments can impose significant costs due to wasted practitioner, assistant, and administrator time. Medical practices also contact patients for a number of other purposes, such as marketing and appointment scheduling. Manually contacting individual patients imposes a substantial administrative burden, and many medical practices employ automated services to contact patients using technologies such as place pre-recorded phone calls. Given the importance of patient messaging in the field of medical practice management and the importance of data security and privacy when dealing with medical record data, improved techniques for communicating with patients are desired.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms, techniques, and computer readable media having instructions stored thereon for performing smart messaging in medical practice communication. In some embodiments, a patient information database may be implemented on one or more storage devices. The patient information database may store patient information related to a plurality of patients of one or more medical practices.

In some embodiments, a patient cluster analysis engine implemented on a processor may be operable to determine a plurality of patient clusters based on the patient information. Each patient cluster may include a respective subset of the plurality of patients that share similar patient information. The patient cluster analysis engine may also be operable to determine a respective default communications pattern for each of the clusters based on the similar patient information. The respective default communications pattern may indicate a mode of communicating with the respective subset of the plurality of patients included in the patient cluster.

According to various embodiments, a patient message scheduler may be configured to schedule a message for transmission to a designated one of the patients in accordance with the respective default communications pattern associated with the patient cluster in which the designated patient is included.

### BRIEF DESCRIPTION OF THE DRAWINGS

The disclosure may best be understood by reference to the following description taken in conjunction with the accompanying drawings, which illustrate particular embodiments.

FIG. 1 illustrates an example of an overview method for smart message scheduling that can be performed in conjunction with various techniques and mechanisms of the present invention.

FIG. 2 illustrates an example of a system that may be used to perform smart messaging operations in conjunction with various techniques and mechanisms of the present invention.

FIG. 3 illustrates one example of a system.

FIG. 4 illustrates one example of a representation of profile cluster determination data configured in accordance with one or more embodiments.

FIG. 5 illustrates one example of a method for assigning one or more patients to profile clusters.

FIG. 6 illustrates one example of an arrangement of patients into clusters.

FIG. 7 illustrates one example of message transmission method that may be performed in accordance with techniques and mechanisms described herein.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, techniques and mechanisms described herein facilitate the conducting of smart messaging between medical practices and patients. Patients of a medical practice may be grouped into clusters based on similar characteristics as represented in data associated with those patients. For example, patients may be clustered based on demographic data, stated communications preference data, observational data about patient behavior, clinic data characterizing a medical practice visited by the patient, and/or other such information. A default communications pattern may be determined for each cluster. The default communications pattern may include information related to communications content, channel, ordering, frequency, timing, and/or other such information for communicating with patients in the cluster. Messages may then be scheduled with patients in a cluster in accordance with the default communications pattern.

### Example Embodiments

Patient communication presents significant information technology challenges for medical practices of all sizes, from single-doctor general practice medicine clinics to multi-clinic dental firms with many dentists working at each clinic. One aspect of patient communication is indirect cost. If a patient misses a scheduled appointment, then the clinic may effectively waste the time of the practitioner and/or assistants who reserved time to handle the appointment. Further, rescheduling appointments can reduce the available time slots for other patients. Finally, patients who must schedule and reschedule appointments may become dissatisfied with a medical clinic due to the inconvenience involved.

Many medical practices employ automated services to contact patients using technologies. However, patients employ an ever-broadening range of communications channels for receiving and sending information. These channels include, but are not limited to: postal services, telephone, voicemail, Short Message Service (SMS), email, and social media services. Some patients prefer certain communications channels over others, and increasingly many patients are non-responsive to communications sent over non-preferred communications channels. Further, different patients are more responsive to receiving information at particular times. For example, some patients are more likely to attend a pre-schedule medical appointment if a reminder notice is sent one week in advance, while other patients are more likely to attend an appointment if the reminder notice is sent one day in advance.

Another aspect of patient communication is direct cost. Manually confirming each appointment with each patient requires substantial amounts of time, imposing a significant labor cost on clinics. Accordingly, many clinics automate some aspects of patient communications, for instance via prerecorded or automatically generated phone messages. However, these automated systems typically employ a one-size-fits-all approach, where all patients of a clinic receive the same type of message sent through the same communications channel (e.g., phone, email, etc.) according to the same schedule (e.g., 3 days before an appointment). A one-size-fits-all approach does not account for the fact that many people favor particular communications channels (e.g., Short Messaging Service (SMS), social media, email, etc.) while disfavoring (or completely ignoring) other communications channels. Nevertheless, patients rarely express specific preferences about how they would like to receive communications from medical clinics.

Despite these difficulties, effective communications are increasingly important. Faced with increasing competition and increasing costs for providing medical services, clinics are pressured to provide services more efficiently and cost effectively. Further clinics are increasingly expanding into different types of messaging, such as marketing. For example, a dental clinic may determine that a patient has a yearly dental insurance limit of $1,500, but that the patient has used only $500 of the total. Accordingly, the clinic may wish to send a message to the patient that the patient might be eligible for an effectively free teeth whitening service should the patient make the appointment for the current year.

According to various embodiments, techniques and mechanisms described herein may be used to address any or all of a set of technical challenges faced by medical practices such as dental clinics, veterinary clinics, and doctor's clinics. Medical practices may effectively communicate with patients in order to provide more effective, lower-cost, higher-quality services. Further, some or all communication may be automated, thus reducing or eliminating the costs involved in conducting manual communication. In addition, communication characteristics such as the content, channel, timing, frequency, and more may be tailored to provide improved communication effectiveness, even when few or no patients express specific preferences about these characteristics. In particular embodiments, techniques and mechanisms described herein provide for new technological capabilities for medical practices that significantly improve upon existing approaches to patient communications.

According to various embodiments, the term “medical practice” or “medical clinic” as used herein may apply to any or all of services related to a wide range of health services practices. These include, but are not limited to, dental clinics, veterinary clinics, doctor's clinics, surgical practices, orthodontics practices, orthopedic practices, and physical therapy practices. Many examples discussed herein refer to sending a message and/or receiving a response or confirmation from a patient. However, it should be noted that in some cases the patient may in actuality be a substantially disabled person, a child, or a pet, in which case the message may instead be sent to a guardian such as a parent, caretaker, or owner. Although the techniques and mechanisms described herein are applicable to such situations, the provided examples will refer to the patient as the message recipient for simplicity.

According to various embodiments, techniques and mechanisms described herein facilitate the scheduling and transmission of messages to patients in a manner calculated to improve medical practice efficiency and patient responsiveness. For example, patient data may be used to determine whether to send a patient a text message one day before an appointment, a pre-recorded voice message a few days before an appointment, or an email message one week before an appointment.

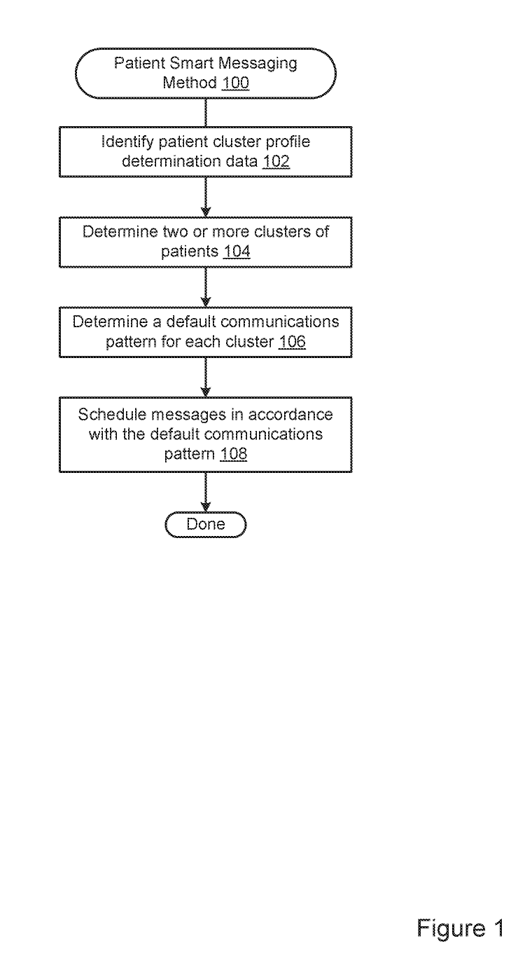

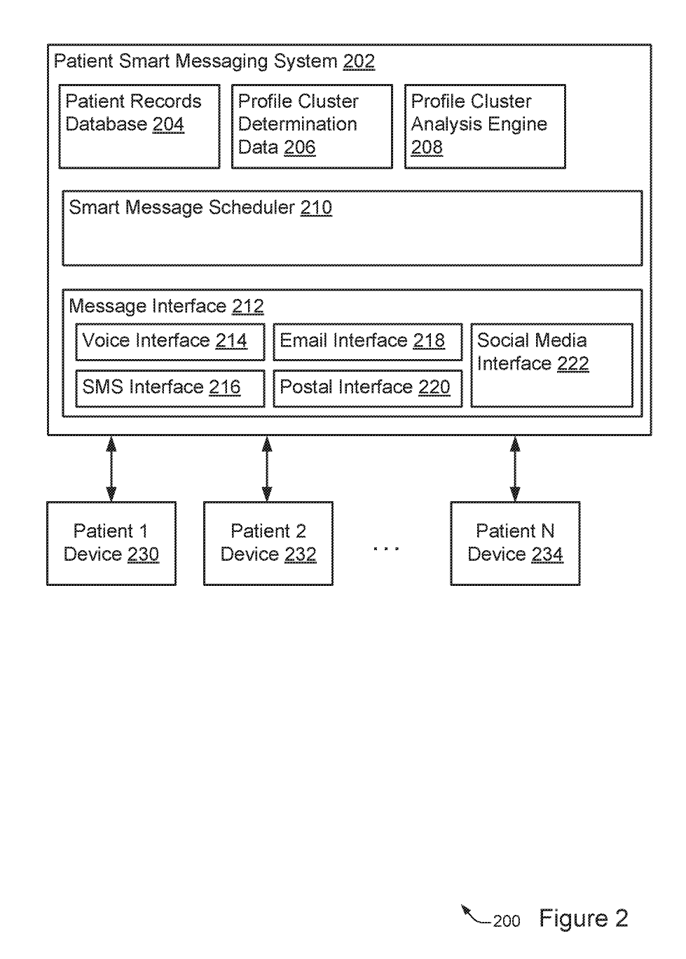

FIG. 1 illustrates an example of an overview method 100 for smart message scheduling that can be performed in conjunction with various techniques and mechanisms of the present invention. According to various embodiments, the method 100 may be performed in order to facilitate more efficient and reliable communications with patients of a medical practice. The method 100 may be performed at a patient smart messaging system. An example of a patient smart messaging system is discussed in additional detail with respect to FIG. 2.

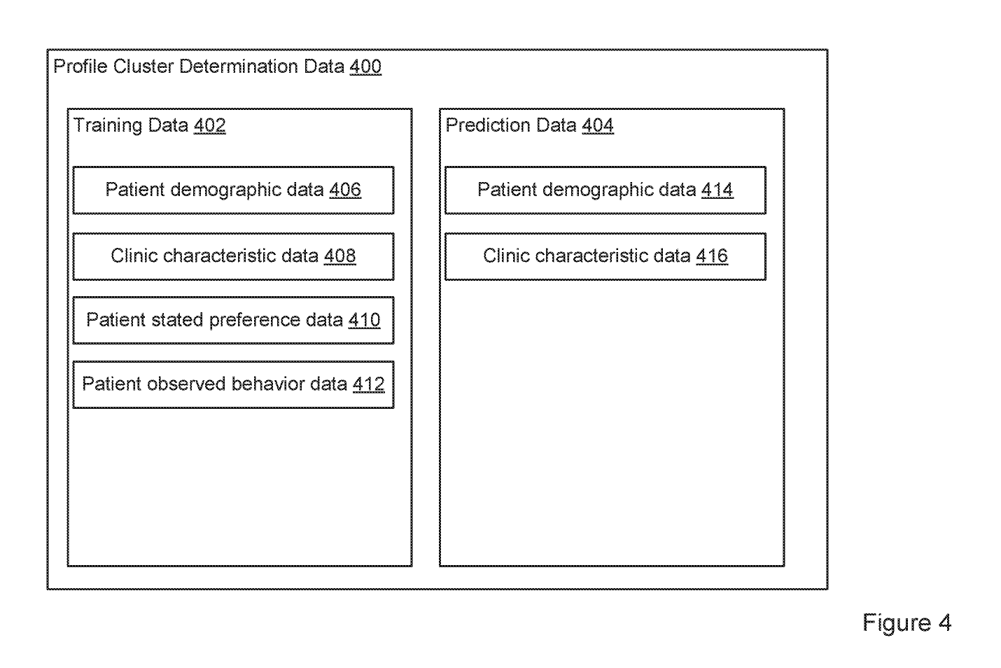

At 102, patient cluster profile determination data is identified. In some implementations, patient cluster profile determination data may include any information suitable for determining how to communicate with particular patients. For example, patient cluster profile determination data may include patient demographic data, clinic characteristic data, patient stated preference data, patient observed behavior data, or any other relevant information. An example of one configuration of patient cluster profile determination data is discussed in further detail with respect to FIG. 4.

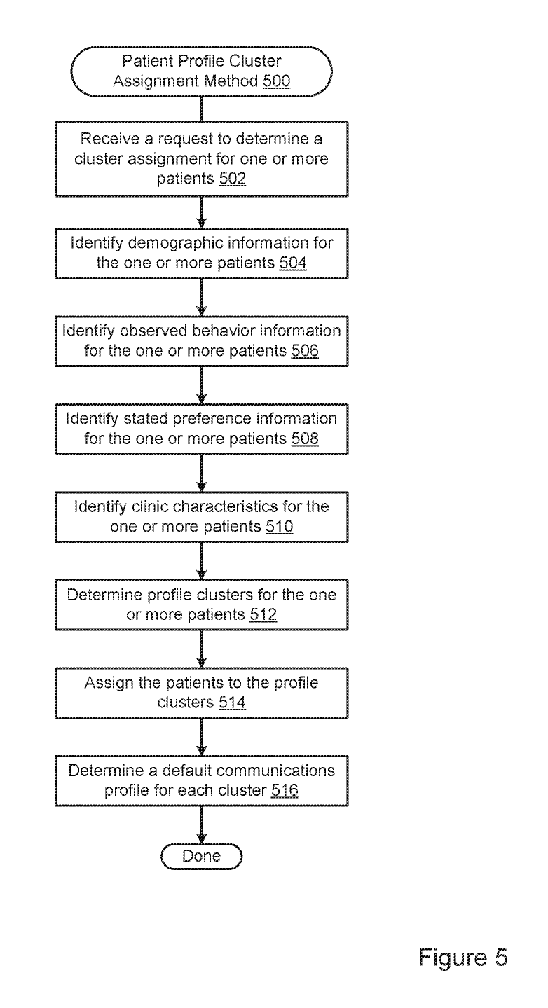

At 104, two or more patient clusters are determined. According to various embodiments, patient clusters may be determined by grouping patients together when those patients share similar patient cluster profile determination data. In a simple example, patients may be grouped together by age. For instance, patients of a medical practice may be grouped into three clusters by age that roughly correspond to generational differences between the cluster groups (e.g., Generation X, Generation Y, Baby Boomers). Techniques for determining patient clusters are discussed in further detail with respect to FIG. 5.

At 106, a default communications pattern is determined for each cluster. In some embodiments, determining a default communications pattern may involve identifying communications characteristics such as communications content, channel, ordering, timing, and frequency suitable calculated to improve communication responsiveness and appointment attendance rates for members of a patient cluster. Techniques for determining a default communications pattern are discussed in additional detail with respect to FIG. 5.

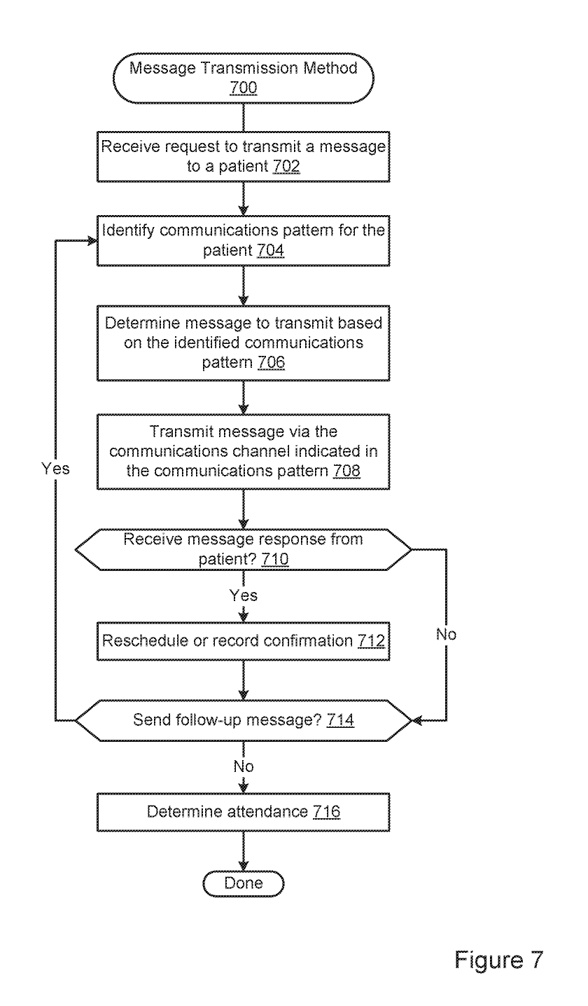

At 108, one or more messages are scheduled in accordance with the default communications pattern. According to various embodiments, messages may be scheduled by applying the default communications pattern to particular patient situations. For example, a patient may have an appointment scheduled on a particular data and may or may not have expressed specific preferences about preferred communications techniques. This patient-specific data may be combined with the default communications pattern to schedule particular messages for transmission to the patient. Techniques for scheduling and transmitting patient communications are discussed in additional detail with respect to FIG. 7.

FIG. 2 illustrates an example of a system 200 that may be used to perform smart messaging operations in conjunction with various techniques and mechanisms of the present invention. The system 200 includes a patient smart messaging system 202 in communication with devices associated with patient devices 230, 232, and 234. The patient smart messaging system 202 includes a patient records database 204, profile cluster determination data 206, a profile cluster analysis engine 208, a smart message scheduler 210, and a message interface 212. The message interface 212 includes a voice interface 214, an SMS interface 216, an email interface 218, a postal interface 220, and a social media interface 222.

According to various embodiments, the patient records database 204 includes information about medical patients of one or more medical practices. For example, the patient records database 204 may include any or all of demographic information, insurance information, past and future appointment scheduling information, medical record information, and other such data.

In some implementations, the profile cluster determination data 206 includes any information suitable for determining clusters of the medical patients represented in the patient records database 204. The profile cluster determination data 206 may include at least a portion of the information stored in patient records database 204, such as patient demographic information. As profile cluster determination data 206 may also include other information, such as information about specific medical clinics. The types of information that may be included in the profile cluster determination data 206 are discussed in additional detail with respect to FIG. 4.

According to various embodiments, the profile cluster analysis engine 208 may process the profile cluster determination data 206 to determine clusters of patients. The clustering process may involve identifying groups of patients that share similar profile cluster determination data. By clustering patients that share similar data, a default communications pattern may be determined for patients. Techniques for clustering patients are discussed in additional detail with respect to FIG. 5.

In some implementations, the smart message scheduler 210 may be configured to schedule specific messages for transmission to individual patients. The smart message scheduler 210 may schedule messages based at least in part on particular interactions with patients. For instance, a patient may be targeted for appointment scheduling, for confirming and/or attending a scheduled appointment, for a marketing opportunity, or for some other type of interaction. When such an interaction is targeted, the smart message scheduler 210 may schedule one or more messages based on a deadline or target date. For example, when an appointment is scheduled on a particular date, the smart message scheduler 210 may schedule one or more messages to be transmitted in advance of that date to remind the patient of the appointment.

In some implementations, the smart message scheduler 210 may schedule messages based at least in part on a default communications pattern associated with a patient cluster. For example, if a patient has an upcoming appointment and the patient is a member of a patient cluster having a communications pattern indicating that an email sent three days in advance is the default mode of reminding a patient of an appointment, then the smart message scheduler 210 may schedule an email message to be transmitted to the patient three days in advance of the patient's scheduled appointment.

According to various embodiments, the message interface 212 includes one or more interfaces for transmitting messages to patient devices. By facilitating the transmission of different types of messages, the message interface 212 allows communication with patients along different communications channels. For example, the message interface 212 shown in FIG. 2 allows communication via voice, SMS, email, postal service, and one or more social media applications. However, in other configurations, fewer, additional, or different communications channels may be supported. Techniques for scheduling and transmitting messages to patient devices are discussed in additional detail with respect to FIG. 7.

Each communications interface shown in FIG. 2 supports the transmission of communications to patients along a different communications channel. According to various embodiments, the voice interface 214 may be configured to transmit a pre-recorded or automated voice message to a telephone, either as a live message directly to a patient or as a voicemail. Alternately, or additionally, the voice interface 214 may be configured to provide an interactive voice message. For example, the voice interface 214 may be configured to accept user responses provided via a touch tone phone interface or a voice interface. The voice interface 214 may then respond to user input by playing another pre-recorded message or by using artificial intelligence to construct a response via text-to-speech conversion and/or a library of pre-recorded voice loops.

In some implementations, the SMS interface 216 may be configured to transmit an SMS message to a patient's mobile telephone number. The email interface 218 may be configured to transmit an email message to a patient's email address. The postal interface 220 may be configured to perform operations such as printing, stamping, and/or depositing a physical letter or postcard for transmission to the patient's address through a postal service. The social media interface 222 may be configured to transmit a message to the patient via a social messaging service such as Twitter, Facebook, Google+ Instagram, WhatsApp, Weibo, or the like.

The patient devices 230 through 234 may include any devices suitable for receiving messages. For example, a patient device may be a mobile phone, a laptop computer, a desktop computer, a landline phone, a tablet computer, or any other suitable device.

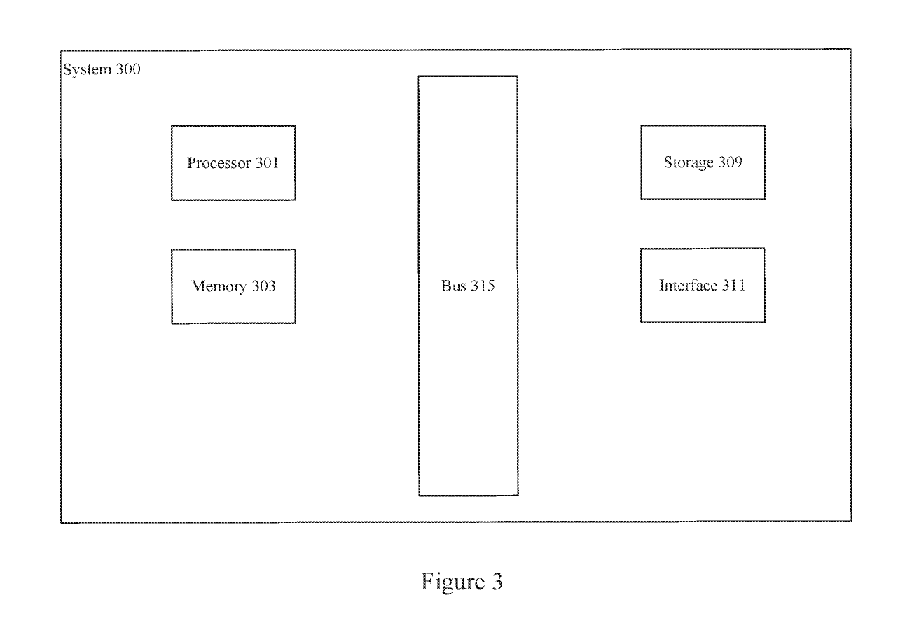

FIG. 3 illustrates one example of a server. According to particular embodiments, a system 300 suitable for implementing particular embodiments of the present invention includes a processor 301, a memory 303, a storage device 309, an interface 311, and a bus 315 (e.g., a PCI bus or other interconnection fabric) and operates as a patient smart messaging system. When acting under the control of appropriate software or firmware, the processor 301 is responsible for performing profile cluster analysis. Various specially configured devices can also be used in place of a processor 301 or in addition to processor 301. The interface 311 is typically configured to send and receive data packets or data segments over a network. The storage device 309 may include one or more of a network attached storage (NAS), a storage area network (SAN) system, a local hard disk, or any other suitable component.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching.

Although a particular server is described, it should be recognized that a variety of alternative configurations are possible. For example, some modules may be implemented on another device connected to the server. A variety of configurations are possible.

FIG. 4 illustrates one example of a representation of profile cluster determination data 400 configured in accordance with one or more embodiments. According to various embodiments, the profile cluster determination data 400 includes training data 402 and prediction data 404. The training data 402 includes patient demographic data 406, clinic characteristic data 408, patient stated preference data 410, and patient observed behavior data 412.

In some implementations, patient demographic data may include any information characterizing the attributes of an individual patient. This information may include, but is not limited to: age, sex, race, medical history, profession, employer, marital status, insurance provider, income level, residence location, and parental status. Such information may be collected when a patient is onboarded at as a new patient at a medical practice for the first time and may be updated periodically, for instance upon each appointment.

In some implementations, clinic characteristic data may include information about a medical practice visited by the patient. Clinic characteristic data may include, but is not limited to: the number of medical practitioners, the number of medical assistants, the number of administrators, the number of patients, location, average patient income level, clinic profitability, insurance provided accepted, practice management software, information technological characteristics, patient demographic profiles. In particular embodiments, the number of medical practitioners may be divided by type. For instance, clinic characteristic data may identify a number of doctors, dentists, veterinarians, hygienists, certified dental assistants, nurses, office managers, receptionists, and the like. Such information may be collected when a clinic is added to the system and may be updated periodically, for instance once per month.

In some embodiments, patient stated preference data may include specific communications preferences provided by the patient. Patients may state preferences such as which communication channel(s) they prefer, when they prefer to receive messages, what types of messages they prefer to receive, and other such information.

In some embodiments, patient observed behavior data may include information indicative of decisions or actions taken by a patient. For example, the patient observed behavior data may indicate whether a patient kept an appointment, read a message, responded to a message, confirmed an appointment, missed an appointment, rescheduled an appointment, canceled an appointment, or took some other action. As another example, patient observed behavior data may include online interaction data such as patient interactions with websites, patient portals, appointment schedulers, and other such interfaces. As yet another example, patient observed behavior data may include clinic and/or patient financial records such as financial transactions, billing statements, accounts receivable, and other such data. In particular embodiments, a patient may have installed a medical app on a mobile device, which may use geolocation data collected from the patient's mobile device to determine whether the patient kept an appointment.

According to various embodiments, different types of data may be available for different patients. For example, patient demographic information may be available for most or all patients, even those that are newly added to the system. Similarly, clinic characteristic data may be available for any patients assigned to one or more specific clinics, which may include most or all patients in the system. However, many patients may not express specific communications preferences. Further, observed behavior related to communications responsiveness, confirmation rates, and appointment attendance may not be available for some patients, such as those newly added to the system.

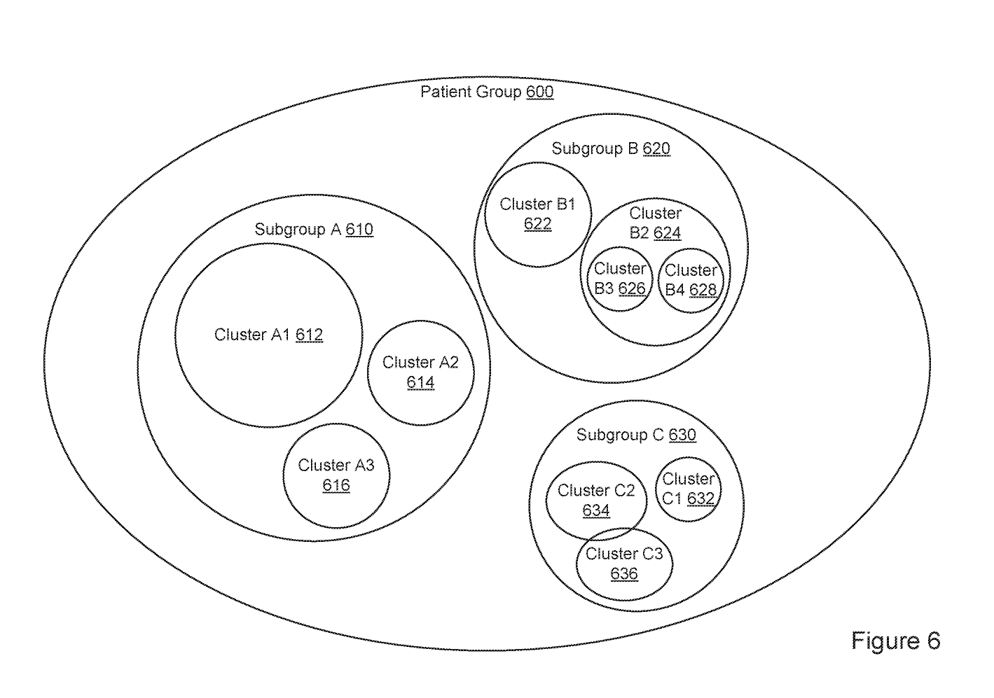

According to various embodiments, patient data may be logically grouped into training data 402 for those patients where more data is available and prediction data 404 for those patients where less data is available. In this way, patients for whom more data is available may be used to predict characteristics of patients for whom less data is available. For instance, patients may be clustered together when they share demographic and/or clinic characteristic data in common. Then, the patient stated preference data and/or the patient observed behavior data available for some patients in a cluster may be used to predict characteristics such as communications responsiveness, confirmation rates, and appointment attendance for patients for whom such data is not available. Techniques for clustering patients and determining default communications patterns are discussed in additional detail with respect to FIGS. 5 and 6.

FIG. 5 illustrates one example of a method 500 for assigning one or more patients to profile clusters. According to various embodiments, the method 500 may be implemented on a profile cluster analysis engine in a patient smart messaging system, such as the profile cluster analysis engine 208 shown in FIG. 2. The method 500 may be used to analyze patient data to determine clusters of patients.

At 502, a request to determine a cluster assignment for one or more parties is received. According to various embodiments, a cluster or clusters may be determined at any or all of various points in time. For example, clusters may be determined when the system is initialized with patient data for the first time. As another example, new patients may be assigned to clusters when they are entered into the system. As still another example, clusters assignments may be periodically reevaluated to reflect new data. For instance, clusters may be reevaluated once per hour, once per day, once per week, once per month, or when a designated number of changes to patient data have been detected.

At 504, demographic information for the one or more patients is identified. At 506, behavior information for the one or more patients is identified. At 508, stated preference information is identified for the one or more patients. At 510, clinic characteristics are identified for the one or more patients. According to various embodiments, the information identified at operations 504-510 may be retrieved from a variety of sources. For example, as discussed with respect to FIG. 2, some patient information may be retrieved from a patient records database. As another example, the patient smart messaging system 202 may maintain clinic-level data describing the characteristics of each clinic or clinics visited by each patient.

At 512, profile clusters are determined for the one or more patients. According to various embodiments, patients may be clustered on any available data. For example, demographic and clinic data may be available for all or virtually all patients. Thus, patients may be grouped according to similarity along demographic and clinic level dimensions to determine an initial assignment of clusters.

In particular embodiments, clusters may be determined in a hierarchical fashion. For example, a particular cluster of patients may include individuals of similar age and income who visit any of several clinics that share similar characteristics in a particular geographic location. However, this cluster of patients may include one group who are observed to be more responsive to email messages and another group who are observed to be more responsive to text messages, without any demographic or clinic data conclusively separating the two groups. In this example, the two groups may be treated as sub-clusters of the larger cluster. However, a new patient may be located in the larger cluster if insufficient information is available to locate the patient in one of the sub-clusters.

According to various implementations, any of a variety of clustering techniques may be used. These techniques include, but are not limited to: K-means clustering, Fuzzy C-means clustering, Hierarchical clustering, and Mixture of Gaussian clustering.

In some embodiments, each collection of data about a patient may be treated as a vector in an N-dimensional space. Then, a distance measure may be calculated between any or all pairs of vectors. Finally, pairs of patients whose vectors have a relatively low distance measure may be grouped into the same cluster. A variety of distance measures may be used, such as for example the Minkowski metric provided by the following formula, where d_{(x,y)} is the distance between patients x and y, n is the number of dimensions in the vector space, i is an index over those dimensions, and p is the order of the metric. In particular embodiments, a value of p=1 or p=2 may be used, rendering the metric a Manhattan distance or a Euclidean distance respectively.

$${d}_{( x , y )} = {( {\sum }_{i}^{n} {\vert {x}_{i} - {y}_{i} \vert}^{p} )}^{\frac{1}{p}}$$

At 514, patients are assigned to the profile clusters. According to various embodiments, for each patient, any available information about the patient may be used to assign the patient to a cluster. For example, an existing patient may be associated with one or more of patient demographic data, clinic characteristic data, patient stated preference data, and patient observed behavior data. However, a new patient may be associated with a more limited selection of data, such as patient demographic data and clinic characteristic data but not observed behavior data or stated preference data.

In particular embodiments, one or more multilabel classification algorithms may be used to assign patients to clusters. In such an algorithm, the number of labels may be determined based on the number of clusters identified by the cluster engine. For example, the number of labels may be the same as the number of clusters. The types of cluster assignment procedures that may be used may include, but are not limited to: K-Nearest Neighbor, Logistic Regression, Random Forest, Extremely Randomized Trees, AdaBoost, Gradient Boosting Trees, and Feedforward Neural Network.

At 516, a default communications pattern is determined for each cluster. In some implementations, the communications pattern may include any information characterizing the content, timing, ordering, frequency, or other such characteristics associated with patient communications. For example, a communications pattern may specify that a patient should be notified by email 7 days prior to an appointment, and that a follow-up message should be sent by SMS 1 day prior to the appointment. As another example, a communications pattern may specify that a patient should be sent a voice message 5 days prior to an appointment, and that a follow-up message should be sent by email only if the patient does not confirm the appointment. As yet another example, the system may identify a cluster of patients that have failed to keep appointments in the past. For these patients, the communications pattern may indicate that follow-up messages should continue to be sent until the patient confirms, or the appointment will be canceled.

According to various embodiments, the default communications pattern for a cluster may be determined at least in part by identifying effective communications characteristics based on observed behavior and/or expressed preferences for patients within the cluster. For example, observed behavior and/or expressed preference data may be available for some of the patients in a cluster, while such data may be missing for other patients in the cluster. Accordingly, the non-missing data may be analyzed to determine a default communications pattern for all patients in the cluster.

In particular embodiments, the default communications pattern for a cluster may be specified manually or be generated based on a manually-specified rule. For example, an administrator may know or intuit that younger patients tend to prefer to communicate via SMS while older patients tend to communicate via phone. As another example, a rule may specify that wealthier clusters of patients should receive communications via email while less wealthy patients should receive communications via phone.

FIG. 6 illustrates one example of an arrangement of patients into clusters. The patient group 600 includes a number of patients across potentially many different medical clinics. For example, the patient group 600 may include all patients known to the smart messaging system. The patients are divided into subgroups 610, 620, and 630 and into clusters 612, 614, 616, 622, 624, 626, 628, 632, 634, and 636.

In particular embodiments, patients included in the smart messaging system may be divided into subgroups and then clustered within those subgroups. For example, patients may be divided into subgroups based on characteristics such as geographic location or clinic type. Alternately, patients may be clustered across the entire system without division into subgroups. The decision as to whether to divide patients into subgroups may be made at least in part based on whether patients in different geographic locations or clinic types tend to exhibit similar relationships between observable characteristics and communications responsiveness.

According to various embodiments, clusters may differ along dimensions such as size and number. For example, a subgroup of patients may initially be divided into a relatively limited number of clusters. However, as more patients are added to the system and as more data is available for clustering, the number of clusters may be increased in order to refine the communications patterns used to guide communications with patients. In some instances, individual patients may not be members of a cluster. For example, patients with data that is relatively dissimilar to that of other patients may be treated individually or assigned a general default communications pattern applicable to unclassified patients.

In particular embodiments, one or more clusters may be arranged in a hierarchical fashion. For example, cluster B3 626 and cluster B4 628 are both members of the cluster B2 624. Such a situation may arise when patients naturally cluster along one variable, such as age, while dividing along another variable, such as income.

In particular embodiments, one or more clusters may overlap. That is, a patient may be a member of two different clusters. For example, cluster C2 634 overlaps with cluster C3 636. Such as situation may arise when patients are on the boundaries of two clusters. For instance, such patients may be assigned a communications pattern that represents a merging of the default communications patterns of the different clusters of which the patients are members.

FIG. 7 illustrates one example of message transmission method 700 that may be performed in accordance with techniques and mechanisms described herein. According to various embodiments, the message transmission method 700 may be performed by one or more components of a patient smart messaging system, such as the smart message scheduler 210 in communication with the message interface 212.

At 702, a request to transmit a message to a patient is received. In some implementations, the request may be transmitted by a smart message scheduler that has scheduled a message for transmission. Scheduling a message for transmission may be triggered by an event such as an approaching appointment for a patient. The method 700 may be performed to send any of a variety of messages, such as appointment confirmation messages, follow-up reminders, marketing messages, birthday messages, or any other such communications.

At 704, a communications pattern for the patient is identified. According to various embodiments, the communications pattern may be determined based at least in part on the cluster or clusters in which the patient is a member. For example, in the method 500 shown in FIG. 5 the patient may be assigned to a cluster that is associated with a default communications pattern, which may then be used to govern communications with the patient. As another example, the patient may have previously expressed specific preferences regarding the frequency, channel, content, or other characteristic of communications with the patient. In these cases, the patient's expressed preferences may override the default communications profile associated with the patient's cluster.

At 706, a message to transmit is determined based on the identified communications pattern. According to various embodiments, different communications profiles may be associated with different messages. For example, an appointment confirmation message transmitted via SMS may be considerably shorter than an appointment confirmation message transmitted via email. As another example, a message may be tailored to the patient to reflect information such as patient name, appointment details, patient preferences, and other such characteristics. As yet another example, message tone may differ across patient communications profiles, even between messages sent via the same communications channel.

At 708, the message is transmitted via the communications protocol indicated in the communications pattern. For example, the message may be transmitted via an interface such as those in the message interface 212 in FIG. 2.

At 710, a determination is made as to whether a message response has been received from the patient. According to various embodiments, the message interface 212 may be configured to receive responses to messages via any of the communications channels discussed herein. For example, a patient who received an appointment reminder via SMS message may be able to confirm the appointment by transmitting an SMS response, by phone, by email, or by any other suitable communications channel.

At 712, if a message response has been received, then the patient's appointment is confirmed or rescheduled as necessary. In some implementations, confirming an appointment may involve storing an indication of the confirmation in a database such as the patient records database 204 shown in FIG. 2. Rescheduling an appointment may involve initiating further communications between the clinic, the patient smart messaging system, and the patient.

At 714, a determination is made as to whether to send a follow-up message. According to various embodiments, the determination may be made based on any or all of a number of factors, such as the patient's communications pattern, whether the patient responded to the message, the patient's past attendance record, and the amount of time remaining before the appointment. For example, a particular patient communications profile may indicate that patients in a patient cluster should be sent an initial message via email 7 days prior to an appointment and a follow-up message via SMS on the day immediately preceding the appointment. As another example, a different patient communications profile may indicate that a patient would like to receive a follow-up message only in the event that the patient did not confirm the initial message. As yet another example, still a different patient communications profile may indicate that patients in a patient cluster should be sent a single message 3 days before an appointment via phone or voicemail, with no follow-up message regardless of whether the first message was confirmed.

At 716, if no follow-up message needs to be transmitted, then a determination is made as to whether the appointment was kept. In some implementations, a clinic patient management system may transmit a message to the smart messaging system indicating whether a patient kept an appointment. Alternately, or additionally, the patient smart messaging system may determine this information in other ways, such as via an app installed on a patient's mobile phone or via financial record data. Attendance information may be used to further refine patient smart messaging.

According to various embodiments, one or more of the operations shown in FIG. 7 may be performed in a different order, or may be omitted entirely. For example, one or more clinics may not be configured for providing appointment attendance records.

According to various embodiments, the method 700 shown in FIG. 7 may be adapted to transmit any of a variety of types of messages. For example, the method 700 may be used to send an initial marketing message and/or one or more follow-up messages.

In particular embodiments, the method 700 may be used to perform recall/recare operations. For example, medical patients typically receive prophylactic care on a regular basis (e.g., medical checkup once per year, dental checkup twice per year, etc.). Accordingly, the system may periodically scan patient records to identify any patients who are due for a regularly-scheduled appointment in the future but who have not actually scheduled such an appointment.

According to various embodiments, when the system identifies such a patient, the system may initiate a request to transmit a message to the patient at operation 702. The message transmitted at operation 708 may invite the patient to book an appointment electronically or to contact the medical office to book an appointment via another method, such as phone. If the patient fails to respond to the initial message, then the system may send one or more follow-up messages at operation 714.

In particular embodiments, clusters related to appointments, recare/recall, and marketing may vary since patient responses may vary based on the type of message and delivery mechanism. For example, the clustering procedure may assign a patient to a particular cluster for appointments and a different cluster for marketing messages. As another example, the clustering procedure may be run separately to create entirely different patient clusters for patient recare/recall and patient appointments.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A system comprising:
a patient information database implemented on one or more storage devices, the patient information database storing patient information related to a plurality of patients of one or more medical practices;
a patient cluster analysis engine implemented on a processor, the patient cluster analysis engine operable to determine a plurality of patient clusters based on the patient information, each patient cluster including a respective subset of the plurality of patients, the respective subset of the plurality of patients sharing similar patient information, wherein the patient cluster analysis engine is further operable to determine a respective default communications pattern for each of the clusters based on the similar patient information, the respective default communications pattern indicating a mode of communicating with the respective subset of the plurality of patients included in the patient cluster; and
a patient message scheduler configured to schedule a message for transmission to a designated one of the patients, the message scheduled for transmission in accordance with the respective default communications pattern associated with the patient cluster in which the designated patient is included.

2. The system recited in claim 1, wherein each of a first subset of the plurality of patients is associated with respective observational data related to communications pattern responsiveness for the patient, and wherein each of a second subset of the plurality of patients is not associated with respective observational data related to communications pattern responsiveness for the patient, and wherein determining the plurality of patient clusters comprises determining estimated data related to communications pattern responsiveness for the second subset of the plurality of patients.

3. The system recited in claim 1, wherein the patient cluster analysis engine is operable to determine the plurality of patient clusters via a mechanism selected from the group consisting of: centroid-based clustering, distribution-based clustering, density-based clustering, and connectivity-based clustering.

4. The system recited in claim 1, wherein the patient cluster analysis engine is configured to assign the plurality of patients to the plurality of clusters based on the patient information, and wherein the patient information comprises clinic characteristic information and patient demographic information.

5. The system recited in claim 4, wherein the patient cluster analysis engine is configured to assign the plurality of patients to the plurality of clusters via a mechanism selected from the group consisting of: K-Nearest Neighbor, Logistic Regression, Random Forest, Extremely Randomized Trees, AdaBoost, Gradient Boosting Trees, Feedforward Neural Network.

6. The system recited in claim 1, wherein the patient information includes patient demographic data, the patient demographic data indicating a respective age and a respective location for selected ones of the plurality of patients.

7. The system recited in claim 1, wherein the patient information includes patient observed behavior data, the patient observed behavior data indicating a respective behavior pattern for selected ones of the plurality of patients, the respective behavior pattern indicating an attendance rate or a message confirmation rate.

8. The system recited in claim 1, wherein the patient information includes clinic data, the clinic data including information characterizing selected ones of the one or more medical practices.

9. The system recited in claim 1, wherein the patient information includes patient stated preference data, the patient stated preference data indicating a respective preferred communications pattern for selected ones of the plurality of patients, the respective preferred communications pattern indicating one or more of the plurality of communications channels.

10. The system recited in claim 1, the system further comprising:
a message interface capable of sending messages via a plurality of communications channels.

11. The system recited in claim 1, wherein the plurality of communications channels includes an email service, the email service configured to transmit the message within an email.

12. The system recited in claim 1, wherein the plurality of communications channels includes a telephone voice message service, the telephone voice message service configured to transmit the message via spoken audio or voicemail.

13. The system recited in claim 1, wherein the plurality of communications channels includes a Short Message Service (SMS) service, the SMS service configured to transmit the message as an SMS message.

14. The system recited in claim 1, wherein the plurality of communications channels includes an automated postal service, the automated postal service configured to transmit the message within a physical letter via a physical postal service.

15. A method comprising:
retrieving patient information from a patient information database implemented on one or more storage devices, the patient information related to a plurality of patients of one or more medical practices;
determining a plurality of patient clusters based on the patient information via a processor, each patient cluster including a respective subset of the plurality of patients, the respective subset of the plurality of patients sharing similar patient information;
determining a respective default communications pattern for each of the clusters based on the similar patient information via the processor, the respective default communications pattern indicating a mode of communicating with the respective subset of the plurality of patients included in the patient cluster, and
scheduling a message for transmission to a designated one of the patients, the message scheduled for transmission in accordance with the respective default communications pattern associated with the patient cluster in which the designated patient is included.

16. The method recited in claim 15, wherein each of a first subset of the plurality of patients is associated with respective observational data related to communications pattern responsiveness for the patient, and wherein each of a second subset of the plurality of patients is not associated with respective observational data related to communications pattern responsiveness for the patient, and wherein determining the plurality of patient clusters comprises determining estimated data related to communications pattern responsiveness for the second subset of the plurality of patients.

17. The method recited in claim 15, wherein the patient cluster analysis engine is operable to determine the plurality of patient clusters via a mechanism selected from the group consisting of: centroid-based clustering, distribution-based clustering, density-based clustering, and connectivity-based clustering.

18. The method recited in claim 15, wherein the patient information includes patient demographic data, the patient demographic data indicating a respective age and a respective location for selected ones of the plurality of patients, and wherein the patient information includes patient observed behavior data, the patient observed behavior data indicating a respective behavior pattern for selected ones of the plurality of patients, the respective behavior pattern indicating an attendance rate or a message confirmation rate.

19. The method recited in claim 15, wherein the patient information includes clinic data, the clinic data including information characterizing selected ones of the one or more medical practices, and wherein the patient information includes patient stated preference data, the patient stated preference data indicating a respective preferred communications pattern for selected ones of the plurality of patients, the respective preferred communications pattern indicating one or more of the plurality of communications channels.

20. One or more non-transitory computer readable media having instructions stored thereon for performing a method, the method comprising:
retrieving patient information from a patient information database implemented on one or more storage devices, the patient information related to a plurality of patients of one or more medical practices;
determining a plurality of patient clusters based on the patient information via a processor, each patient cluster including a respective subset of the plurality of patients, the respective subset of the plurality of patients sharing similar patient information;
determining a respective default communications pattern for each of the clusters based on the similar patient information via the processor, the respective default communications pattern indicating a mode of communicating with the respective subset of the plurality of patients included in the patient cluster; and
scheduling a message for transmission to a designated one of the patients, the message scheduled for transmission in accordance with the respective default communications pattern associated with the patient cluster in which the designated patient is included.
